(19) United States
(12) Patent Application Publication
(10) Pub. No.: US 2024/0015826 A1
(43) Pub. Date: Jan. 11, 2024

(54) MOBILITY WITHOUT RE-ASSOCIATION IN WI-FI NETWORKS

(71) Applicant: Cisco Technology, Inc., San Jose, CA (US)

(72) Inventors: Malcolm M. SMITH, Richardson, TX (US); Indermeet S. GANDHI, San Jose, CA (US); Pooya MONAJEMI, San Jose, CA (US); Stephen M. ORR, Wallkill, NY (US)

(21) Appl. No.: 18/172,970

(22) Filed: Feb. 22, 2023

Related U.S. Application Data
(60) Provisional application No. 63/367,942, filed on Jul. 8, 2022.

(51) Int. Cl. H04W 76/15; H04W 28/02

(52) U.S. Cl. CPC H04W 76/15; H04W 28/0236

(57) ABSTRACT

Techniques for facilitating client mobility without performing re-association are described. An example technique includes receiving, from a first access point (AP), an indication of at least one second AP neighboring the first AP. A multi-link association is performed. The multi-link association includes establishing a first link with the first AP and pre-establishing a second link with the second AP. After performing the multi-link association, the first AP is communicated with at a first instance in time via the first link.

### CROSS-REFERENCE TO RELATED APPLICATIONS

This application claims benefit of co-pending U.S. provisional patent application Ser. No. 63/367,942 filed Jul. 8, 2022. The aforementioned related patent application is herein incorporated by reference in its entirety.

### TECHNICAL FIELD

Embodiments presented in this disclosure generally relate to wireless communication. More specifically, embodiments in this disclosure relate to techniques for facilitating client mobility without performing re-association in wireless networks.

### BACKGROUND

Many applications and use cases today expect client devices to have seamless roaming capabilities. For example, many industrial and extended reality (XR) applications and use cases increasingly expect computing devices to remain connected to networks, regardless of the location of the computing devices. While certain wireless technologies, such as 802.11 based (or Wi-Fi based) standards have reduced roaming time to hundreds of milliseconds, this amount of roaming time may still be too high for certain latency sensitive applications/use cases, including, for example, industrial, XR, automotive, and mining applications/use cases.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIGS. 1A-1C illustrate an example scenario of client mobility within a system, according to one embodiment.

FIG. 2 illustrates a sequence diagram with example operations performed by one or more devices for facilitating client mobility within a system, according to one embodiment.

FIG. 3 illustrates a flowchart of a method for wireless communications, according to one embodiment.

FIG. 4 illustrates an example computing device, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment in this disclosure provides a method for wireless communication. The method includes receiving, from a first access point (AP), an indication of at least one second AP neighboring the first AP. The method also includes performing a multi-link association, comprising establishing a first link with the first AP and pre-establishing a second link with the second AP. The method further includes after performing the multi-link association, communicating with the first AP at a first instance in time via the first link.

Another embodiment presented in this disclosure provides a computing device. The computing device includes a memory and a processor communicatively coupled to the memory. The processor is configured to perform an operation. The operation includes receiving, from a first access point (AP), an indication of at least one second AP neighboring the first AP. The operation also includes performing a multi-link association, comprising establishing a first link with the first AP and pre-establishing a second link with the second AP. The operation further includes after performing the multi-link association, communicating with the first AP at a first instance in time via the first link.

Another embodiment presented in this disclosure provides a computer-readable storage medium. The computer-readable storage medium includes computer executable code, which when executed by one or more processors, performs an operation. The operation includes receiving, from a first access point (AP), an indication of at least one second AP neighboring the first AP. The operation also includes performing a multi-link association, comprising establishing a first link with the first AP and pre-establishing a second link with the second AP. The operation further includes after performing the multi-link association, communicating with the first AP at a first instance in time via the first link.

### Example Embodiments

Certain Wi-Fi technologies, such as 802.11r, may decrease the amount of time that a client device (e.g., client station (STA)) is disconnected from a wireless network, such as a wireless local area network (WLAN). 802.11r, for example, may support mechanisms that allow a client STA to reestablish existing security and/or quality of service (QoS) parameters prior to re-associating to a new access point (AP). These mechanisms can reduce the length of time that connectivity is interrupted between a client STA and Wi-Fi infrastructure when that client device is connecting to a new AP. For example, in some scenarios, 802.11r mechanisms can reduce a client STA's roaming time from tens of seconds to hundreds of milliseconds. However, roaming times in the order of hundreds of milliseconds may still be too large for certain industrial, XR, automotive, and other latency sensitive use cases that rely on wireless technologies, such as Wi-Fi.

To address this, embodiments described herein provide techniques for facilitating client mobility by significantly reducing the roaming time of clients among one or more access points. In some embodiments, the techniques described herein can be used to eliminate the roaming time of clients. As described in one embodiment herein, an AP multi-link device (MLD) may form across a series of physical APs and support connection to a single client STA MLD in the end point. During the initial multi-link association, the AP MLD may send the list of other nearby AP(s) link(s) in a multi-link operation (MLO) element to the client STA MLD. The MLO element may include basic service set identifier(s) (BSSID(s)) of the AP(s) link(s) and their operating channel(s).

The client STA MLD may use the information in the MLO element to pre-establish link(s) (including BSSIDs, keys, etc.) with the neighbor AP(s), even if the client STA MLD may not be able to initially see all the available links with the neighbor AP(s). During client roaming post-association, the client STA MLD and/or AP MLD may use MLO link management features to dynamically enable/disable the link(s) as well as potentially add and remove links as the client STA approaches or departs the associated regions of coverage. In this manner, embodiments described herein allow for significantly reducing (or eliminating) roaming time of clients among one or more access points.

Note, the techniques described herein for facilitating client mobility without performing re-association in wireless networks may be incorporated into (such as implemented within or performed by) a variety of wired or wireless apparatuses (such as nodes). In some implementations, a node includes a wireless node. Such wireless nodes may provide, for example, connectivity to or for a network (such as a wide area network (WAN) such as the Internet or a cellular network) via a wired or wireless communication link. In some implementations, a wireless node may include an AP or a network controller.

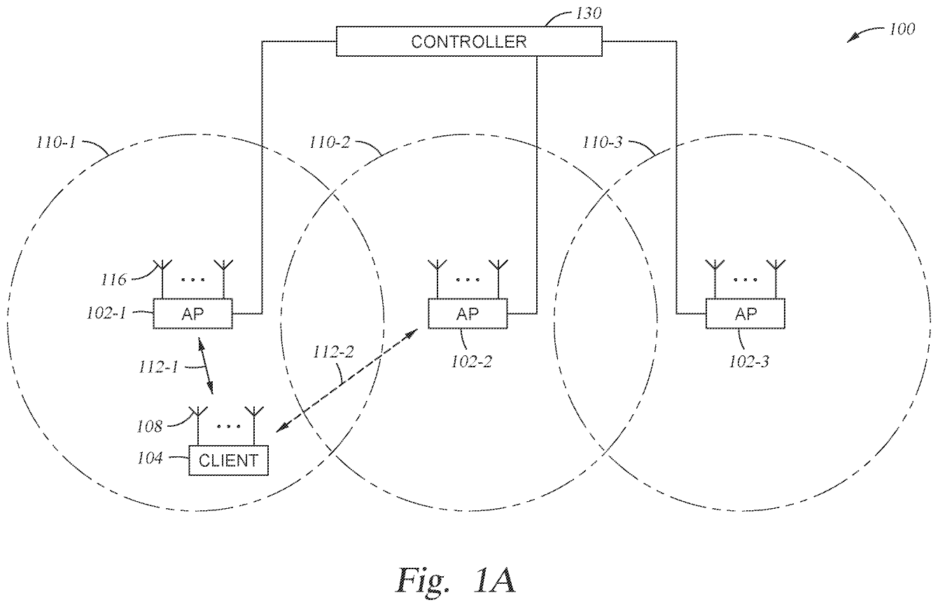

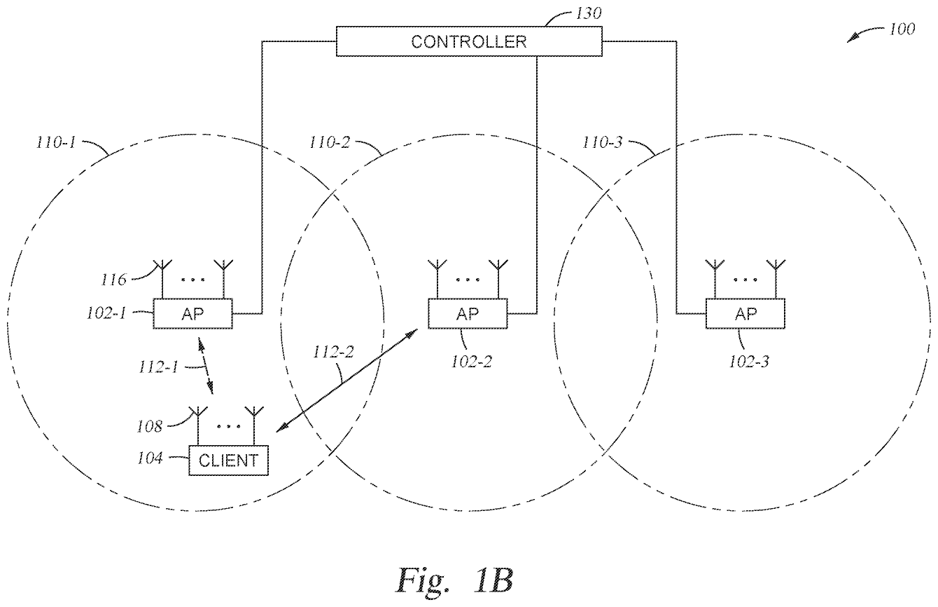

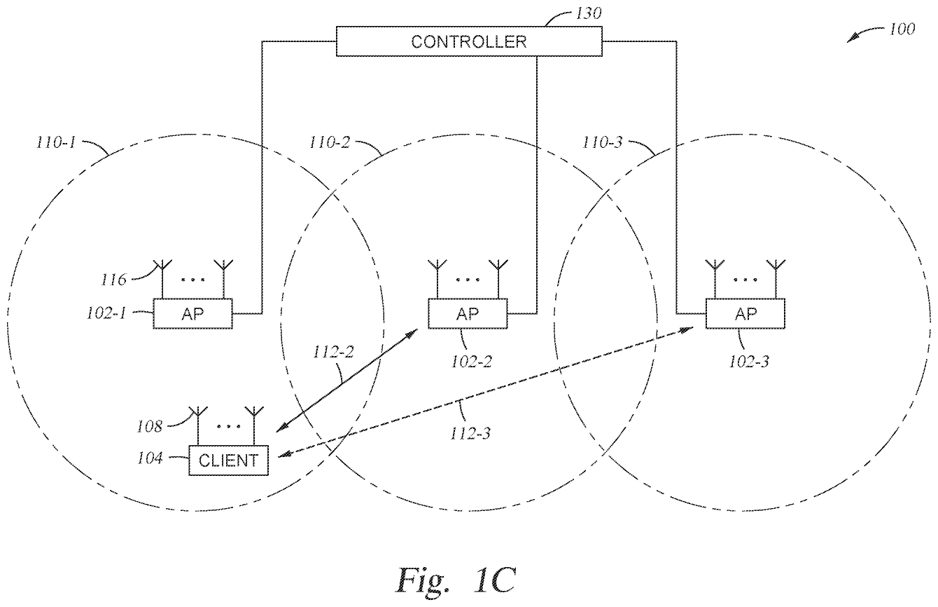

FIGS. 1A-1C illustrates an example system 100 in which one or more techniques described herein can be implemented, according to one embodiment. As shown, the system 100 includes an AP 102-1, AP 102-2, AP 102-3, and a client STA 104. An AP is generally a fixed station that communicates with client STA(s) and may also be referred to as a base station, wireless device, or some other terminology. A client STA may be fixed or mobile and also may be referred to as a mobile STA, a client, a STA, a client device, a wireless device, or some other terminology. Note that while a single client STA 104 is depicted, the system 100 may include any number of client STAs. Similarly, while three APs 102 are depicted, the system 100 may include any number of APs.

As used herein, an AP along with the STAs associated with the AP (e.g., within the coverage area (or cell) of the AP) may be referred to as a basic service set (BSS). Here, AP 102-1 is the serving AP for client STA(s) 104 within cell 110-1. Similarly, AP 102-2 is the serving AP for client STA(s) 104 within cell 110-2, and AP 102-3 is the serving AP for client STA(s) 104 within cell 110-3. AP 102-1 and AP 102-2 are neighboring (peer) APs, and AP 102-2 and AP 102-3 are neighboring (peer) APs. The APs 102 1-3 may communicate with one or more client STAs 104 on the downlink and uplink. The downlink (e.g., forward link) is the communication link from the AP 102 to the client STA(s) 104, and the uplink (e.g., reverse link) is the communication link from the client STA(s) 104 to the AP 102. In some cases, a client STA may also communicate peer-to-peer with another client STA.

As shown in FIGS. 1A-1C, the client STA 104 includes one or more radios 108, and each AP 102 includes one or more radios 116. The client STA 104 uses one or more of the radios 108 to form links with the radios 116 of APs 102 1-3. For example, in FIG. 1A, the client STA 104 may use a first radio 108-1 to form a first wireless link with a radio 116 of AP 102-1, and the client STA 104 may use a second radio 108-2 to form a second wireless link with a radio 116 of AP 102-2. The two wireless links may use different frequency bands. For example, the first wireless link may be formed using a 5 GHz band and the second wireless link may be formed using a 6 GHz band. Note, however, that these are merely example frequency bands and that the two wireless links may use any suitable frequency bands.

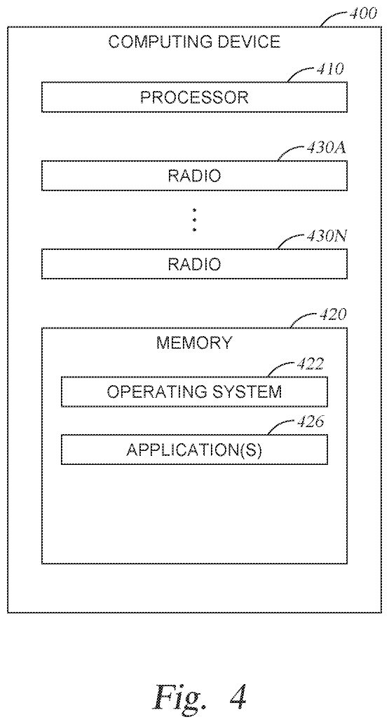

In general, the AP(s) 102 and the client STA 104 may form any suitable number of links for communication using any suitable frequencies. In some instances, the client STA 104 may form multiple links with a single AP 102. In other instances, the client STA 104 may form multiple links with multiple APs 104 (e.g., one link with AP 102-1 and another link with AP 102-2). As a result, the client STA 104 may communicate with one or more APs 102 over multiple links using different frequencies. Example hardware that may be included in an AP 102 and a client STA 104 is discussed in greater detail in regard to FIG. 4.

A controller 130 couples to and provides coordination and control for the APs 102 1-3. For example, the controller 130 may handle adjustments to radio frequency power, channels, authentication, association, and security for the APs. The controller 130 may also coordinate the links formed by the client STA(s) 104 with the APs 102. For example, the controller 130 may coordinate when the client STA 104 and an AP 102 communicate over a link using a particular frequency. As another example, the controller 130 may coordinate the type of data communicated over a particular link. As yet another example, the controller 130 may coordinate when the client STA 104 and the AP 102 form or terminate certain links. As yet another example, the controller 130 may coordinate when the client STA 104 and AP 102 (pre)-associate with each other to (pre)-establish certain links.

In some embodiments, the controller 130 is included within or integrated with an AP 102 and coordinates the links formed by that AP 102. For example, each AP 102 may include a controller that coordinates the links of that AP. In some embodiments, the controller 130 is separate from the APs 102 and coordinates the links of those APs 102. As shown in FIGS. 1A-1C, for example, the controller 130 may communicate with the APs 102 1-3 via a (wired or wireless) backhaul. The APs 102 1-3 may also communicate with one another, e.g., directly or indirectly via a wireless or wireline backhaul.

Although not shown, the controller 130 may include a processor and a memory that perform the actions and functions of the controller 130 described herein. Example hardware that may be included in a controller 130 is discussed in greater detail in regard to FIG. 4. Although three APs 102 are depicted for conceptual clarity, in embodiments, the system 100 may include any number of APs 102, each of which may include any number of radios 116 operating with any suitable frequencies.

Note that the client STA 104 may be referred to as a STA MLD (e.g., a station or client device acting as a multi-link device) and the AP 102 may be referred to as an AP MLD (e.g., an AP that acts as a multi-link device). The STA MLD and AP MLD are generally representative of any device capable of performing multi-link operations. A MLD may generally be classified based on whether it is a single radio MLD or multi-radio MLD. Single radio MLDs generally use a single radio to switch between one or more links. One category of single radio MLDs is Enhanced Multi-Link Single Radio (eMLSR). eMLSR devices generally operate one main wireless radio that can transmit and/or receive data frames on a given link, but can detect some data (e.g., short initial frames) on a set of other links when the device is not actively transmitting or receiving. Multi-radio MLDs may generally be classified into the following two types: (i) simultaneous transmission and reception (STR) MLD and (ii) non-STR MLD. For STR MLDs, a transmission on one link may not affect the operations of frame reception and clear channel assessment (CCA) on other links. Stated differently, for STR MLDs, individual links can operate independently of each other. For non-STR MLDs, the operation on one link may be restricted by the operation on another link. For example, a transmission on one link may not be allowed if it will cause reception interruption on another link. In another example, a reception or CCA on one link may not be allowed if a transmission is ongoing on another link.

In certain embodiments, the system 100 may enable one or more client STAs 104 to roam within a network without performing re-association with one or more APs. Consider the example scenario depicted in FIG. 1A. Here, the client STA 104 associates with AP 102-1 using MLO. As part of the association, a multi-link is established between the client STA 104 and the network (e.g., AP 102-1 and AP 102-2). For example, a link 112-1 is established between the client STA 104 and AP 102-1 and a link 112-2 is pre-established between the client 104 and AP 102-2.

The client STA 104 and AP 102-1 may use link 112-1 to exchange data (e.g., one or more messages). In FIG. 1A, the pre-established link 112-2 may not be used by the client STA 104 and AP 102-2, since the client STA 104 and AP 102-2 may be too far away from each other to hear each other. However, as described below, the client STA 104 may transition to using link 112-2 when the client STA 104 is in proximity to the AP 102-2. In one embodiment, a MLO procedure is used to set up security parameters for the client STA 104 to move to the link 11-2 without relying on the client STA 104 to send a re-association message(s).

As shown in FIG. 1B, when the client STA 104 moves within proximity of AP 102-2, the client STA 104 can switch its traffic to link 112-2 without performing re-association, since the link 112-2 is pre-established. Here, the client STA's 104 traffic has moved to link 112-2 and link 112-1 is unused. In on embodiment, the client STA 104 switches the traffic from link 112-1 to link 112-2 when the signal strength (e.g., received signal strength indication (RSSI)) of link 112-1 is below a (first) threshold and the signal strength (e.g., RSSI) is greater than a (second) threshold.

In certain embodiments, as the client STA 104 moves away from the coverage of an AP, the client STA 104 may perform link disable and link enable operations to continue connectivity with the network. For example, as shown in FIG. 1C, as the client STA 104 moves away from the coverage of AP 102-1, the client STA 104 performs link disable to remove (or delete) link 112-1 and performs link enable to pre-establish (or add) link 112-3 with AP 102-3. In one embodiment, the client STA 104 establishes the security context for link 112-3 without hearing beacons broadcast from AP 102-3. For example, the client STA 104 may use guidance information from AP 102-2 to establish the link 112-3 security context. Such guidance information, for example, may include at least one of an indication to delete link 112-1, an indication to pre-establish link 112-3, or security context information for link 112-3.

In this manner, as the client STA 104 moves in its roaming path (e.g., from cell 110-1 to cell 110-2 to cell 110-3), the client STA 104 may not have to send a re-association frame to any of the APs 102 1-3 along the path, thereby avoiding a break-before-make scenario.

In FIGS. 1A-1C, the beacons' signal strength (e.g., RSSIs) from APs in the client STA's roaming path acts as triggers for link switching and/or link reconfiguration. In one embodiment, there exists a set of thresholds for link enablement or disablement (through Traffic Identifier (TID)-to-link mapping), and another set of thresholds for link addition or deletion. That is, once beacons from an AP reach a first RSSI threshold, the client STA 104 can add the corresponding link to the link set, but might keep it disabled. With another threshold value, the client STA can enable that link (e.g., by sending TID mapping signals on the currently active link). Then, if the RSSI value of the beacons exceeds the RSSI on the existing active link, the client can switch the traffic to the new link. Conversely, a link might be disabled once it reaches below one RSSI threshold, and it may be deleted from the multi-link (ML) setup if it reaches below another (lower) threshold.

In FIGS. 1A-1C, the client STA 104 may perform an association procedure that allows the client STA 104 to have concurrent association with more than one physical AP device at a time. In one embodiment, the client STA 104 may initiate the association procedure by indicating its extended-MLD capability and requesting a list of neighbors. A few exchange sequences are possible such as:
a) Client sends a probe request, indicating extended-MLD capability and requesting a list of neighbors. AP responds with the requested list included in a unicast probe response. Client sends association request frame with all or a subset of the neighbors;
b) Client sends an association request, indicating extended-MLD capability and requesting a list of neighbors. AP sends association response, with the initial ML setup including only co-located radios on the same AP. A list of neighbors is sent along in the same association response frame. The client performs a link-add operation to include the neighbors; and
c) A (smaller) list of neighbors is sent in AP beacons. Client sends an association request requesting all or a subset of these neighbors.

In all the cases above, the client STA 104 can optionally send a beacon report to indicate proximity to any neighbors.

Additionally, as shown in FIGS. 1B-1C, embodiments enable the client STA 104 to use link addition and/or link deletion as tools in the roaming mechanism. Current wireless technologies (e.g., 802.11be) may not support link addition mechanisms without requiring re-association. In contrast, embodiments described herein allow a client STA 104 to use link addition and link removal features without having to know about all APs 102 on the client STA's path in advance. Each AP 102 that is part of the overall MLD can advertise only its neighboring AP's as part of the MLD, and the roaming client STA is able to smoothly add and delete links from its MLD setup without requiring re-association. Then, as shown in FIG. 1B, as the client STA 104 is in the coverage of AP 102-2 and switches the data packets to link-2 (BSSID-2), it can remove the link with AP 102-1 (BSSID-1). Here, the client STA 104 can send ML delete to AP 102-2 to delete the link with the previous AP (AP 102-1). Thus, the delete operation can continue as the client STA 104 moves from one AP to another.

In some embodiments, seamless roaming can still be achieved with relatively good quality without a direct link addition mechanism. In such embodiments, the list of neighboring APs in a coverage area (up to a limit) is sent to the client STA 104. In the interest of increasing the coverage area and reducing the number of required links to be pre-established, certain radios (e.g., 2.4 GHz radios) from a set of APs that provide sufficient coverage may be included. Once the client STA roams outside of the coverage area of the initially established link set, it may have to perform re-association (albeit with far smaller frequency in any roaming scenario).

In one embodiment, a number of requirements for multi-link operation is specified, such as coordination in buffering, block ACKs, Non-Simultaneous Transmit-Receive (NSTR) link transmission alignment, etc. Observing that not all such requirements may be possible to achieve between physically separated APs, embodiments herein propose signaling that indicates the pairs of APs/radios that are capable of a tight (802.11be-compliant) MLO vs. pairs that offer a partial level of coordination. This information is transmitted to the client devices in association response frames (and potentially in other frames and/or elements such as Reduced Neighbor Report (RNR), Beacons, and Probe Responses).

In one embodiment, the set of limitations in partial coordination are common between all physically separated APs. These limitations can be predefined in a specification, or announced via capability bits in Beacons etc., or listed in one separate element. With the limitations defined, the co-located bit in the RNR frame can then be used to derive the restrictions with one AP paired with the transmitting AP. In an association response frame, however, a full bitmap is transmitted indicating the coordination level between each pair of APs included in the ML Setup. In one embodiment, the same bitmap is then repeated during a link-add operation for all sets of APs included in the ML setup.

In order to maintain support for legacy MLD devices incapable of performing the roaming operations defined here, the APs can to continue advertising only their co-located radios as participants in the MLD when sending Beacons and/or broadcast probe responses. Information about neighbors may be included in a new extended-ML element (which is unrecognizable by legacy MLD devices). In unicast communication such as association request/response or unicast probing, this information may be included in the conventional ML element.

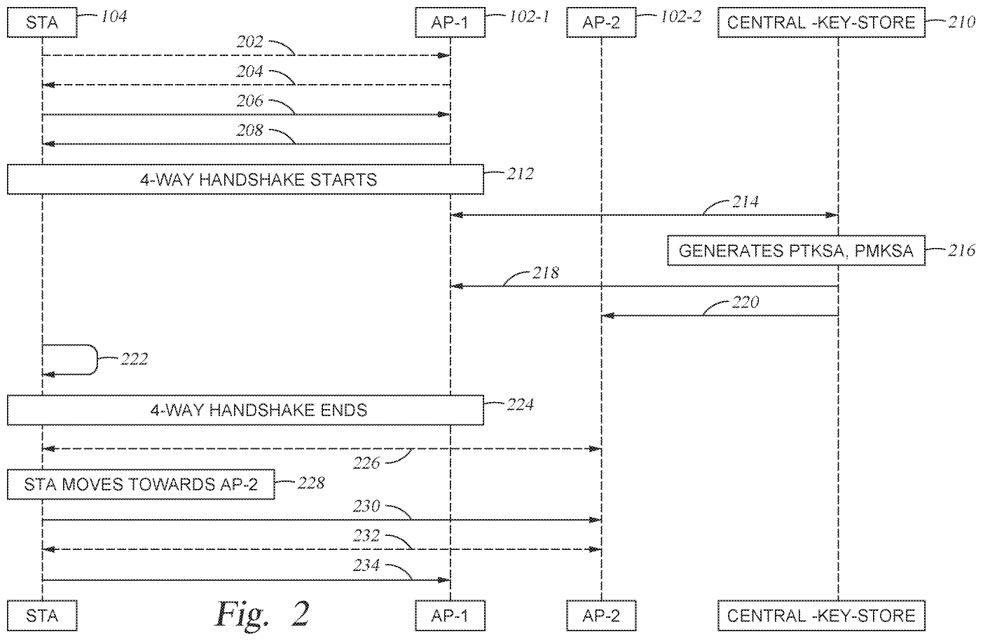

FIG. 2 illustrates a sequence diagram 200 illustrating example operations performed by a client STA 104, an AP 102-1, and AP 102-2, and a central-key-store 210, according to one embodiment. Here, AP 102-1 communicates on a link having a link identifier=1 (e.g., link-id 1) and AP 102-2 communicates on a link having a link identifier=2 (e.g., link-id 2). In one embodiment, the sequence diagram 200 may be performed when the client STA 104 is initially in proximity to AP 102-1. Here, at step 202, the client STA 104 transmits a unicast probe request to AP 102-1 (e.g., Unicast Probe Req [Extended-MLD capability, Requesting Neighbor AP links]). The unicast probe request includes an extended MLD capability indication for client STA 104, and an indication that the client STA is requesting one or more neighbor AP links. At step 204, the AP 102-1 transmits a unicast probe response to the STA 104 (e.g., Unicast Probe Resp [ExtendedMLD-MAC, AP-2, link-id=2]). The unicast probe response includes an extended ML capability indication for AP 102-1, an indication of the neighbor AP (e.g., AP 102-2), and an indication of the link identifier of the neighbor AP (e.g., link-id 2).

At step 206, the client STA 104 transmits an association request to AP 102-1 (e.g., Association Req [AP-1, link-id=1, ExtendedML={Neighbor AP-2, link-id=2}]). The association request includes a request for establish a link with AP 102-1 and a request to pre-establish a link with AP 102-2. For example, the association request includes an indication of the link identifier (e.g., link-id 1) for AP 102-1, and an extendedML information element indicating the link identifier for the neighbor AP (e.g. link-id 2).

At step 208, the AP 102-1 transmits an association response to the client STA 104 (e.g., Association Resp [AP-1, link-id=1, ExtendedML={Neighbor AP-2, link-id=2}]. The association response includes an indication of the link identifier (e.g., link-id 1) for AP 102-1 and the extendedML information element indicating the link identifier for the neighbor AP (e.g., link-id 2). At step 212, the client STA 104 and AP 102-1 participate in a 4-way handshake (e.g., extensible authentication protocol (EAP) handshake). At step 214, the AP 102-1 generates a master session key (MSK) for communicating with the client STA 104 (e.g., MSK generation). At step 216, the central-key-store 210 generates pairwise transient key security association (PTKSA) and pairwise master key security association (PMKSA) using MLD-MAC for link 112-1 (e.g., link-id 1) on AP 102-1 and link 112-2 (e.g., link-id 2) on AP 102-2.

At step 218, the central-key-store 210 transmits PTKSA and PMKSA for client STA 104 association, and group transient key security association (GTKSA), integrity group temporal key security association (IGTKSA), and beacon integrity group temporal key association (BIGTKA) for link 112-1 to the AP 102-1. At step 220, the central-key-store 210 transmits PTKSA and PMKSA for client STA 104 association, and GTKSA, IGTKSA, and BIGTKA for link 112-2 to the AP 102-2. At step 222, the client STA 104 generates PTKSA, PMKSA for STA association, and GTKSA, IGTKSA, and BIGTKA for each link 112-1 and link 112-2. At step 224, the 4-way handshake between the client STA 104 and AP 102-1 ends. At step 226, the client STA 104 and AP 102-1 exchange traffic over link 112-1.

When the client STA 104 moves towards AP 102-2, the client STA 104 may determine to switch its traffic from link 112-1 to link 112-2 (step 228). In one embodiment, the client STA 104 may determine to switch its traffic to link 112-2 when the beacon RSSI of AP 102-2 link 112-2 is greater than the beacon RSSI of AP 102-1 link 112-1. At step 230, the client STA 104 transmits a link-enable message to AP 102-2 (e.g., Link-Enable [Link-id=2]). The link-enable message includes an indication of the link identifier for link 112-2 (e.g. link-id 2). At step 232, the client STA 104 and AP 102-2 exchange traffic over link 112-2 using the generated security keys (e.g., PTKSA, PMKSA). At step 234, the client STA 104 transmits a link-disable message to AP 102-1 (e.g., Link-Disable [Link-id=1]). The link-disable message includes an indication of the link identifier for link 112-1 (e.g. link-id 1).

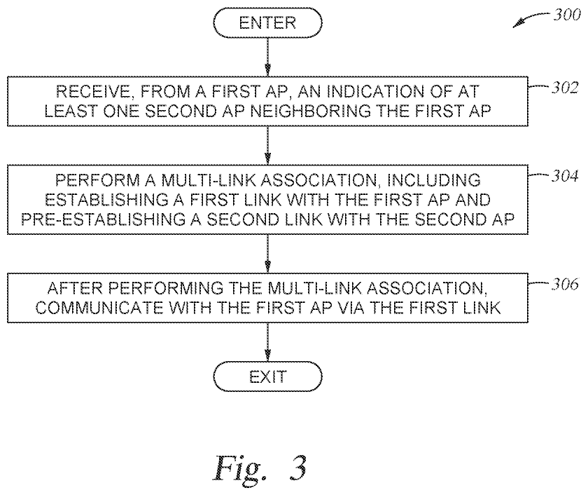

FIG. 3 is a flowchart of a method 300 for wireless communication, according to one embodiment. The method 300 may be performed by a client STA (e.g., client STA 104).

Method 300 enters at block 302, where the client STA receives, from a first AP (e.g., AP 102-1), an indication of at least one second AP (e.g., AP 102-2) neighboring the first AP. In one embodiment, the indication of the at least one second AP is received via a (unicast) probe response message. For example, the probe response message may include an extended-MLD capability of the first AP and an indication of at least one second link (e.g., a link identifier) associated with the at least one second AP.

At block 304, the client STA performs a multi-link association, including establishing a first link (e.g. link 112-1) with the first AP and pre-establishing a second link (e.g., link 112-2) with the second AP. In one embodiment, the client STA may perform the multi-link association by transmitting an association request message to the first AP. The association request message may include a request to establish the first link and a request to pre-establish the second link. In one embodiment, the request to pre-establish the second link may include an extended ML information element indicating the second link (e.g., a link identifier). In one embodiment, as part of establishing the first link and pre-establishing the second link, the client STA may generate security context information for each of the first link and the second link.

At block 306, the client STA communicates with the first AP at a first instance in time via the first link. In one embodiment, the method 300 further includes communicating with the second AP at a subsequent second point in time via the second link, upon detecting that a condition is satisfied. In one example, the condition may include (i) a signal strength of one or more beacons from the first AP being less than a threshold and (ii) a signal strength of one or more beacons from the second AP being greater than the threshold.

FIG. 4 illustrates an example computing device 400, according to one embodiment. The computing device 400 can be configured to perform one or more techniques described herein for facilitating client mobility within a network without performing re-association. For example, the computing device 400 can perform method 300 and any other techniques (or combination of techniques) described herein. The computing device 300 can be a client STA (e.g., client STA 104), an AP (e.g., AP 102) or a controller (e.g., controller 130). The computing device 400 includes a processor 410, a memory 420, and one or more radios 430a-n (generally, radio 430).

The processor 410 may be any processing element capable of performing the functions described herein. The processor 410 represents a single processor, multiple processors, a processor with multiple cores, and combinations thereof. The communication interfaces 430 facilitate communications between the computing device 400 and other devices. The communications interfaces 430 are representative of wireless communications antennas and various wired communication ports. The memory 420 may be either volatile or non-volatile memory and may include RAM, flash, cache, disk drives, and other computer readable memory storage devices. Although shown as a single entity, the memory 420 may be divided into different memory storage elements such as RAM and one or more hard disk drives.

As shown, the memory 420 includes various instructions that are executable by the processor 410 to provide an operating system 422 to manage various functions of the computing device 400. As shown, the memory 420 includes the operation system 422 and one or more application(s) 426.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method for wireless communication, comprising:
receiving, from a first access point (AP), an indication of at least one second AP neighboring the first AP;
performing a multi-link association, comprising establishing a first link with the first AP and pre-establishing a second link with the second AP; and
after performing the multi-link association, communicating with the first AP at a first instance in time via the first link.

2. The method of claim 1, further comprising, upon detecting that a condition is satisfied, communicating with the second AP at a subsequent second point in time via the second link.

3. The method of claim 2, wherein communicating with the second AP comprises refraining from transmitting a re-association frame to the second AP upon detecting that the condition is satisfied.

4. The method of claim 2, wherein the condition comprises (i) a signal strength of one or more beacons from the first AP being less than a threshold and (ii) a signal strength of one or more beacons from the second AP being greater than the threshold.

5. The method of claim 2, further comprising, prior to communicating with the at least one second AP via the second link, transmitting a message to the second AP to enable the second link upon detecting that the condition is satisfied.

6. The method of claim 2, further comprising transmitting a message to the first AP to disable the first link upon detecting that the condition is satisfied.

7. The method of claim 1, wherein establishing the first link with the first AP and pre-establishing the second link with the second AP comprises generating security context information for each of the first link and the second link.

8. The method of claim 1, wherein:
receiving the indication of the at least one second AP comprises receiving a probe response message comprising an extended multi-link device information element; and
the extended multi-link device information element comprises an extended multi-link device capability of the first AP and an identifier of the second link.

9. The method of claim 1, wherein performing the multi-link association further comprises transmitting an association request to the first AP, the association request comprising (i) a request to establish the first link and (ii) a request to pre-establish the second link.

10. The method of claim 9, wherein the request to pre-establish the second link comprises an extended multi-link device information element comprising an identifier of the second link.

11. A computing device, comprising:
a memory; and
a processor communicatively coupled to the memory, the processor being configured to perform an operation comprising:
receiving, from a first access point (AP), an indication of at least one second AP neighboring the first AP;
performing a multi-link association, comprising establishing a first link with the first AP and pre-establishing a second link with the second AP; and
after performing the multi-link association, communicating with the first AP at a first instance in time via the first link.

12. The computing device of claim 11, further comprising, upon detecting that a condition is satisfied, communicating with the second AP at a subsequent second point in time via the second link.

13. The computing device of claim 12, wherein communicating with the second AP comprises refraining from transmitting a re-association frame to the second AP upon detecting that the condition is satisfied.

14. The computing device of claim 12, wherein the condition comprises (i) a signal strength of one or more beacons from the first AP being less than a threshold and (ii) a signal strength of one or more beacons from the second AP being greater than the threshold.

15. The computing device of claim 12, further comprising, prior to communicating with the at least one second AP via the second link, transmitting a message to the second AP to enable the second link upon detecting that the condition is satisfied.

16. The computing device of claim 12, further comprising transmitting a message to the first AP to disable the first link upon detecting that the condition is satisfied.

17. The computing device of claim 11, wherein establishing the first link with the first AP and pre-establishing the second link with the second AP comprises generating security context information for each of the first link and the second link.

18. The computing device of claim 11, wherein:
receiving the indication of the at least one second AP comprises receiving a probe response message comprising an extended multi-link device information element; and
the extended multi-link device information element comprises an extended multi-link device capability of the first AP and an identifier of the second link.

19. The computing device of claim 11, wherein performing the multi-link association further comprises transmitting an association request to the first AP, the association request comprising (i) a request to establish the first link and (ii) a request to pre-establish the second link.

20. A computer-readable storage medium comprising computer executable code, which when executed by one or more processors, performs an operation comprising:
receiving, from a first access point (AP), an indication of at least one second AP neighboring the first AP;
performing a multi-link association, comprising establishing a first link with the first AP and pre-establishing a second link with the second AP; and
after performing the multi-link association, communicating with the first AP at a first instance in time via the first link.
